(19) United States
(12) Patent Application Publication
(10) Pub. No.: US 2026/0175819 A1
(43) Pub. Date: Jun. 25, 2026

(54) VEHICLE INTERIOR COMPONENT

(71) Applicant: Dr. Ing. h.c. F. Porsche Aktiengesellschaft, Stuttgart (DE)

(72) Inventor: Thomas GROSCHOPF, Rutesheim (DE)

(21) Appl. No.: 19/415,857

(22) Filed: Dec. 11, 2025

(30) Foreign Application Priority Data
Dec. 19, 2024 (DE) 10 2024 138 826.9

(51) Int. Cl. B60S 1/64; B60N 2/90; B60N 3/04; B60R 5/04; D06G 1/00

(52) U.S. Cl. CPC B60S 1/64; D06G 1/00; B60N 2/90; B60N 3/042; B60N 3/044; B60R 5/044

(57) ABSTRACT

A vehicle interior component includes a surface configured as a textile and a vibration generator configured to generate a vibration of the surface to remove contaminants present on the surface. The textile includes a dielectric elastomer which deforms elastically in response to an electrical voltage applied to the elastomer. The vibration generator is electrically coupled to the elastomer and configured such that the vibration generator applies the electrical voltage oscillating at an oscillation frequency to the elastomer of the textile in order to generate the vibration of the surface.

### CROSS REFERENCE TO RELATED APPLICATIONS

This application claims benefit to German Patent Application No. DE 10 2024 138 826.9, filed on Dec. 19, 2024, which is hereby incorporated by reference herein.

### FIELD

The present invention relates to a vehicle interior component with a surface designed as a textile.

### BACKGROUND

A vehicle interior component is disclosed in the form of a vehicle seat from US 2021 0 162 959 A1 and comprises a vibration generator for generating a vibration of the surface to remove contaminants present on the surface. In the vehicle interior component, the vibration generator is configured to stimulate vibrations throughout the entire vehicle seat. The vibration of the vehicle seat can also be used as a massage function for a person sitting on the vehicle seat.

A similar vehicle interior component is disclosed in DE 10 2019 008 314 A1, in which the vehicle interior component is again formed by a vehicle seat, wherein the vibration generator has an actuator installed in the vehicle floor which causes the entire vehicle seat to vibrate.

Another similar vehicle interior component is disclosed in DE 10 2018 222 652 A1, in which the vehicle interior component is also formed by a vehicle seat, while in this case the vibration generator is configured as an ultrasonic emitter that only excites the surface of the vehicle seat to vibrate.

Vibration generators that can cause vibrations in the respective surface or the entire vehicle interior component are relatively large, whereby a correspondingly large amount of effort is required, which also goes hand in hand with a comparatively large installation space requirement.

CN 116 494 917 A describes a method for removing dust from a vehicle interior, in which sound waves are used to self-clean the vehicle interior.

DE 10 2012 005 109 A1 describes a surface cleaning device for vehicle windows and exterior mirrors, which has a vibration layer applied to the hard surface of the mirror or window that can vibrate at a predetermined excitation frequency. The natural frequency of the vibration layer is used as the excitation frequency. The vibration layer may be configured as an electroactive polymer layer.

### SUMMARY

In an embodiment, the present disclosure provides a vehicle interior component. The vehicle interior component includes a surface configured as a textile and a vibration generator configured to generate a vibration of the surface to remove contaminants present on the surface. The textile includes a dielectric elastomer which deforms elastically in response to an electrical voltage applied to the elastomer. The vibration generator is electrically coupled to the elastomer and configured such that the vibration generator applies the electrical voltage oscillating at an oscillation frequency to the elastomer of the textile in order to generate the vibration of the surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a vehicle interior component.

### DETAILED DESCRIPTION

Embodiments of the present invention provide an improved design for a vehicle interior component, which can be integrated into the respective vehicle interior component with comparatively little effort. Embodiments also minimize the space required for installation.

Embodiments of the present invention are based on the general idea of equipping the textile with a dielectric or electroactive elastomer. Such a dielectric elastomer is characterized by the fact that it deforms elastically depending on the electrical voltage applied to it. The deformation increases with increasing stress. As the tension decreases, the elastomer relaxes and the deformation decreases again due to the elasticity of the elastomer. The vibration generator can now be configured to generate an electrical voltage oscillating at a vibration frequency and apply it to the elastomer, causing the surface to vibrate. By integrating the dielectric elastomer, which corresponds to an elastomer structure made of dielectric or electroactive elastomer, into the textile, the vehicle interior component presented here requires little additional installation space. The vibration generator, for example, does not require an actuator to generate mechanical vibrations and therefore requires little installation space.

In this context, “configuration” is synonymous with “design” and/or “setup” and/or “programming”, so that the phrase “configured so that” is synonymous with the phrase “designed and/or set up and/or programmed so that”.

In embodiments, the textile comprises a dielectric elastomer, i.e., an elastomer structure made of dielectric elastomer, which deforms elastically in response to an electrical voltage applied to it, wherein the vibration generator is electrically coupled to the elastomer and configured in such a way that the vibration generator applies an electrical voltage oscillating at a vibration frequency to the elastomer of the textile in order to generate a vibration of the surface.

In embodiments, the dielectric elastomer or elastomer structure is configured in such a way that two electrical connection regions are provided for applying the electrical voltage, wherein the vibration generator is electrically coupled to the elastomer by means of these electrical connection regions.

According to an advantageous embodiment, the textile may comprise a textile material into which the elastomer or elastomer structure is incorporated. To achieve this, the textile only needs to be slightly modified to accommodate the elastomer.

In embodiments, the elastomer can be incorporated into the textile material in the form of fibers. The textile material itself consists of fibers that can be woven, knitted, or processed in other ways, making it particularly easy to incorporate the fibrous elastomer during the production of the textile material.

According to an advantageous embodiment, the vehicle interior component may be equipped with at least one sensor system for detecting contaminants on the surface. The vibration generator can now be coupled with this sensor system and also configured so that the vibration generator stimulates vibrations on the surface when the sensor system detects contaminants on the surface. This ensures that the surface of the vehicle interior component is only cleaned as required and also automatically, as the vibration device is only activated when the sensor system detects current contaminants on the surface.

In embodiments, the sensor system can operate optically or, in particular embodiments, using ultrasound. The sensor system may comprise a radar sensor or a lidar sensor.

According to an advantageous embodiment, the sensor system can be configured to detect and distinguish between two or more different types of contaminants. The vibration generator can now be configured to select the vibration frequency with which it excites the elastomer depending on the type of contaminants detected by the sensor system. As a result, the vibration generator can, for example, select a first vibration frequency for a first type of contaminants and select a second vibration frequency for a second type of contaminants, which differs from the first vibration frequency. For example, the sensor system can distinguish between coarse contaminants and fine contaminants. For example, the sensor system can distinguish between small stones as coarse contaminants and grains of sand as fine contaminants. The sensor system can also distinguish between solid contaminants and liquid contaminants.

In embodiments, the sensor system can be equipped with a sensor configured to detect and distinguish between different types of contaminants. It is also conceivable that the sensor system has two or more sensors that are specialized for different types of contaminants, so that, for example, a first sensor can detect at least one type of contaminants, while a second sensor can detect at least another type of contaminants.

According to an advantageous embodiment, the textile and/or the vibration generator may be configured such that the vibrating surface transports the contaminants in a predetermined direction along the surface. In particular embodiments, the vibration allows the textile to function as a kind of conveyor belt, enabling targeted transport of the contaminants along the surface. This transport effect may depend on the nature of the textile, the vibration frequency, and the type of contaminants.

In embodiments, the textile and/or the vibration generator are configured in such a way that the vibrating surface transports the contaminants to a collection point formed in or on the vehicle interior component. For example, the collection point may be formed at an opening or in an opening in the surface or at an edge of the surface. This makes it particularly easy to remove contaminants from the surface.

In another advantageous embodiment, the vehicle interior component may comprise a dirt collection container arranged at or in the collection point in such a way that the contaminants transported to the collection point enter the dirt collection container due to the vibration of the surface. In other words, the collection point is formed in the dirt collection container. This allows the surface to be cleaned automatically. The contaminants can be discreetly collected in the dirt collection container and easily removed from there. For example, the dirt collection container can be easily removed from the vehicle interior component and emptied. It may also be provided that the dirt collection container is easily accessible for a vacuum cleaner, so that the dirt collection container can be easily emptied using the vacuum cleaner.

According to an advantageous embodiment, the vehicle interior component may be designed as a floor mat. In other words, the vehicle interior component may be a floor mat. A relatively large amount of contaminants can accumulate, especially in the region of doormats. The self-cleaning function of the vehicle interior component presented here makes it relatively easy to keep the floor mat clean.

According to another embodiment, the vehicle interior component may be designed as a carpet or as a vehicle seat or as a child seat or as a trunk cover, or may be a carpet or a vehicle seat or a child seat or a trunk cover. The carpet can cover the entire floor of the vehicle interior. The carpet can also cover the trunk floor.

It is understood that the aforementioned features and the features yet to be explained below are usable not only in the respectively specified combination but also in other combinations, or on their own, without departing from the scope of the invention as defined by the claims. The components mentioned above and the components yet to be mentioned below of a higher-level unit, such as a device, an apparatus, or an arrangement, which are labeled separately, can constitute separate parts or components of this unit or can be integral regions or portions of this unit, even if shown otherwise in the drawing.

An example embodiment of the invention is shown in the drawing and is explained in further detail in the following description, wherein identical reference signs refer to identical, similar, or functionally identical components.

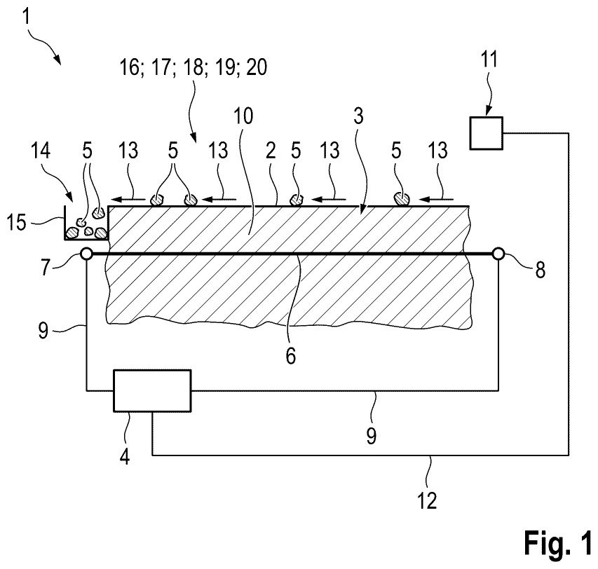

According to FIG. 1, vehicle interior component 1 (shown in cut away) comprises a surface 2 that is designed as a textile 3. The vehicle interior component 1 also has a vibration generator 4 configured to generate vibration of the surface 2, wherein the vibration of the surface 2 serves to remove contaminants 5 located on the surface 2 from the surface 2.

The textile 3 contains a dielectric elastomer 6, which may be configured in particular embodiments as a fabric. The dielectric or electroactive elastomer 6 represents an elastomer structure 6 formed from a dielectric elastomer. The elastomer structure 6 or the elastomer 6 is configured in such a way that it deforms elastically in response to an electrical voltage applied to it. The elastomer 6 has two electrical connection regions 7, 8, via which an electrical voltage can be applied to the elastomer 6 in order to elastically deform the elastomer 6. The vibration generator 6 is electrically connected to the elastomer 6. This can be achieved, for example, via electrical control lines 9 that are electrically connected to the electrical connection regions 7, 8 of the elastomer 6. The vibration generator 4 is now configured so that it can apply an electrical voltage oscillating at a vibration frequency to the elastomer 6, which causes the elastomer 6 to deform in accordance with the vibration frequency. The incorporation of elastomer 6 into textile 3 causes textile 3, and thus ultimately surface 2, to vibrate in accordance with the oscillation frequency. These vibrations then cause the contaminants 5 to be removed from the surface 2.

The vibration generator 4 is therefore purely electric and does not require an actuator to generate mechanical vibrations. In particular embodiments, this also makes it possible to position the vibration generator 4 largely independently of the vehicle interior component 1, as long as the electrical connection to the elastomer 6 is ensured. At the same time, the vibration generator 4 is relatively small, so that it can also be easily integrated into a flat vehicle interior component 1.

The textile 3 conveniently features a textile material 10 into which the elastomer 6 is incorporated. For example, the elastomer 6 may be incorporated into the textile material 10 in the form of fibers. It is conceivable that the textile material 10 is woven or knitted or otherwise manufactured using conventional textile fibers in combination with the fibers from the dielectric elastomer 6.

The vehicle interior component 1 presented here can optionally be equipped with a sensor system 11 for detecting contaminants 5 on or in the surface 2. The vibration generator 4 can, for example, be electrically coupled to the sensor system 11 by means of a signal line 12. In addition, the vibration generator 4 can be configured so that it only causes the surface 2 to vibrate when the sensor system 11 has detected contaminants 5 on the surface 2 and has transmitted this information to the vibration generator 4 via the signal line 12.

According to an advantageous embodiment, the sensor system 11 can be configured to detect at least two different types of contaminants and distinguish between them. In addition, the vibration generator 4 can now be configured to select the vibration frequency depending on the type of contaminants 5 detected by the sensor system 11. For example, a different vibration frequency may be suitable for removing coarse contaminants than a vibration frequency that is suitable for removing fine contaminants. As a result, this significantly improves the cleaning effect for surface 2 of vehicle interior component 1.

According to an advantageous embodiment, the textile 3 and/or the vibration generator 4 may be configured such that the vibrating surface 2 transports the contaminants 5 in a predetermined direction along the surface 2. In FIG. 1, such a directed transport effect 13 is indicated by arrows. In particular embodiments, the textile 3 and/or the vibration generator 4 may be configured such that the vibrating surface 2 transports the contaminants 5 to a collection point 14 formed in or on the vehicle interior component 1. The collection point 14 may, for example, be located at an edge or an opening of the vehicle interior component 1 or the surface 2. The textile 3 may have standing fibers that are inclined relative to the direction of gravity, whereby the vibration of the surface 2 produces the directional transport effect 13. Similarly, the vibration frequency with which the vibration generator 4 causes the surface 2 to vibrate can be adjusted to the textile 3 and/or the contaminants 5 in such a way that the desired directional transport effect 13 is achieved.

In the embodiment shown in FIG. 1, the vehicle interior component 1 is equipped with a dirt collection container 15, which is arranged at or in the collection point 14. The vibration of surface 2 ultimately conveys the contaminants 5 transported to collection point 14 into the dirt collection container 15. In this respect, collection point 14 is located here in the dirt collection container 15.

The vehicle interior component 2 may conveniently be a floor mat 16. Similarly, the vehicle interior component 1 may be a carpet 17 or a vehicle seat 18 or a child seat 19 or a trunk cover 20.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A vehicle interior component, comprising:
a surface which is a textile; and
a vibration generator configured to generate a vibration of the surface to remove contaminants present on the surface,
wherein the textile comprises a dielectric elastomer which is configured to deform elastically in response to an electrical voltage applied to the elastomer, and
the vibration generator is electrically coupled to the elastomer and configured such that the vibration generator applies the electrical voltage oscillating at an oscillation frequency to the elastomer of the textile in order to generate the vibration of the surface.

2. The vehicle interior component according to claim 1, wherein the textile comprises a textile material into which the elastomer is incorporated.

3. The vehicle interior component according to claim 2, wherein the elastomer is incorporated into the textile material in a form of fibers.

4. The vehicle interior component according to claim 1, wherein the vehicle interior component further comprises a sensor system configured to detect the contaminants on the surface, and wherein the vibration generator is coupled to the sensor system and is configured such that the vibration generator excites the surface to vibrate when the sensor system detects the contaminants on the surface.

5. The vehicle interior component according to claim 4, wherein the sensor system is configured to detect and distinguish between at least two different types of contaminants, and wherein the vibration generator is configured to select a vibration frequency depending on a type of the at least two different types of the contaminants detected by the sensor system.

6. The vehicle interior component according to claim 1, wherein the textile or the vibration generator are configured such that the vibrating surface transports the contaminants in a predetermined direction along the surface.

7. The vehicle interior component according to claim 1, wherein the textile or the vibration generator are configured such that the vibrating surface transports the contaminants to a collection point formed in or on the vehicle interior component.

8. The vehicle interior component according to claim 7, wherein the vehicle interior component further comprises a dirt collection container which is arranged at or in the collection point such that the contaminants transported to the collection point enter the dirt collection container based on the vibration of the surface.

9. The vehicle interior component according to claim 1, wherein the vehicle interior component is configured as a floor mat or is a floor mat.

10. The vehicle interior component according to claim 1, wherein the vehicle interior component is configured as one of a carpet, a vehicle seat, a child seat, a trunk cover, or is one of the carpet, the vehicle seat, the child seat, or the trunk cover.
